(19) United States
(12) Patent Application Publication
(10) Pub. No.: US 2012/0206742 A1
(43) Pub. Date: Aug. 16, 2012

(54) PRINTING RAISED-LINE PICTURES FOR THE VISUALLY IMPAIRED

(75) Inventors: Yolanda Palomo, Hawthorne, CA (US); Navpreet Singh, Rancho Palos Verdes, CA (US)

(73) Assignee: XEROX CORPORATION, Norwalk, CT (US)

(21) Appl. No.: 13/028,554

(22) Filed: Feb. 16, 2011

(51) Int. Cl. G06K 1/00

(52) U.S. Cl. 358/1.9

(57) ABSTRACT

Methods and devices receive a first image. The first image comprises at least one visible feature. These methods and devices process the first image to identify at least one outline of the visible feature and store the outline as a second image. These methods and devices also emboss the second image on a sheet of media as an embossed print. The embossing processes comprises printing marking material on the sheet of media in a pattern matching the outline using a predetermined quantity of marking material, which is a sufficient amount of marking material to create a topographical feature on the sheet of media detectible by a human touch.

### BACKGROUND

Embodiments herein generally relate to printing methods and printing devices and more particularly to methods and devices that provide raised-line pictures to assist the visually impaired.

Millions of people in the world are legally blind. They rely on their sense of touch to see the world around them. Raised-line pictures help produce images that they can feel, but in order for a photograph to become a raised-line picture it must undergo an expensive and long process that begins with the negative film of the picture (see, for example, U.S. Pat. No. 4,522,914, the complete disclosure of which is incorporated herein by reference) and ends with an expensive printing process. Today, photographs go straight to digital and are not processed on film, and film impressions and processing are becoming more expensive.

### SUMMARY

An exemplary method herein receives a first image. The first image comprises one or more visible features. This exemplary method processes the first image to identify one or more outlines of the visible features and stores the outline(s) as a second image. In some embodiments, the second image can consist only of a background and the outline(s).

This exemplary method also embosses the second image on a sheet of media as an embossed print. The embossing processes comprises printing marking material on the sheet of media in a pattern matching the outline(s) using a predetermined quantity of marking material, which is a sufficient amount of marking material to create a topographical feature on the sheet of media detectible by a human touch. The printing can comprise ink jet printing of visible or clear ink, or laser printing of visible or clear toner. The topographic features are formed by a mass of the marking material extending from a surface of the sheet of media and, for example, the topographic feature can have a height of at least 0.25 mm, 0.5 mm, 1.0 mm, 1.5 mm, etc., above the surface of the sheet.

Another exemplary method herein also processes the first image to identify one or more outlines of the features and stores the outline(s) as a second image. However, this exemplary embodiment prints the first image on a sheet of media as a visibly printed sheet. Then, this method embosses the second image on the visibly printed sheet as an embossed print. This embossing process comprises printing marking material on the visibly printed sheet in a pattern matching the at least one outline using a predetermined quantity of marking material. Again, the predetermined quantity of marking material comprises a sufficient amount of marking material to create a topographical feature on the visibly printed sheet detectible by a human touch.

An exemplary printing machine embodiment herein comprises at least one processor; at least one computer-readable storage device operatively connected to the processor; and at least one marking engine operatively connected to the processor. The processor receives a first image. Again, the first image comprises at least one visible feature. The processor processes the first image to identify at least one outline of the feature(s). The processor stores the outline(s) as a second image in the computer-readable storage device.

The marking engine comprises an ink jet print engine printing visible or clear ink (solid or liquid); or a laser print engine printing visible or clear toner. The marking engine embosses the second image on a sheet of media as an embossed print. The embossing process again comprises the marking engine printing marking material on the sheet of media in a pattern matching the outline(s) using a predetermined quantity of marking material, which is a sufficient amount of marking material to create a topographical feature on the sheet of media detectible by a human touch.

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a top-view schematic diagram of an image according to embodiments herein;

FIG. 2 is a top-view schematic diagram of an image according to embodiments herein;

FIG. 3 is a top-view schematic diagram of an image printed on a sheet of media according to embodiments herein;

FIG. 4 is a cross-sectional schematic diagram of an image printed on a sheet of media according to embodiments herein;

FIG. 5 is a schematic diagram of an image according to embodiments herein;

FIG. 6 is a schematic diagram of an image according to embodiments herein;

FIG. 7 is a top-view schematic diagram of an image according to embodiments herein;

FIG. 8 is a top-view schematic diagram of an image printed on a sheet of media according to embodiments herein;

FIG. 9 is a cross-sectional schematic diagram of an image printed on a sheet of media according to embodiments herein;

FIG. 10 is a flow diagram illustrating various embodiments herein; and

FIG. 11 is a semantic diagram illustrating various device embodiments herein.

### DETAILED DESCRIPTION

As mentioned above, raised-line pictures are useful for the visually impaired; however, these can sometimes require film negatives to produce, and usually involve a quite expensive production process. However, with embodiments herein, raised-line drawings (which are sometimes referred to as “impressions”) are created using a standard printing function of a standard inkjet or laser printer on regular paper or photo paper.

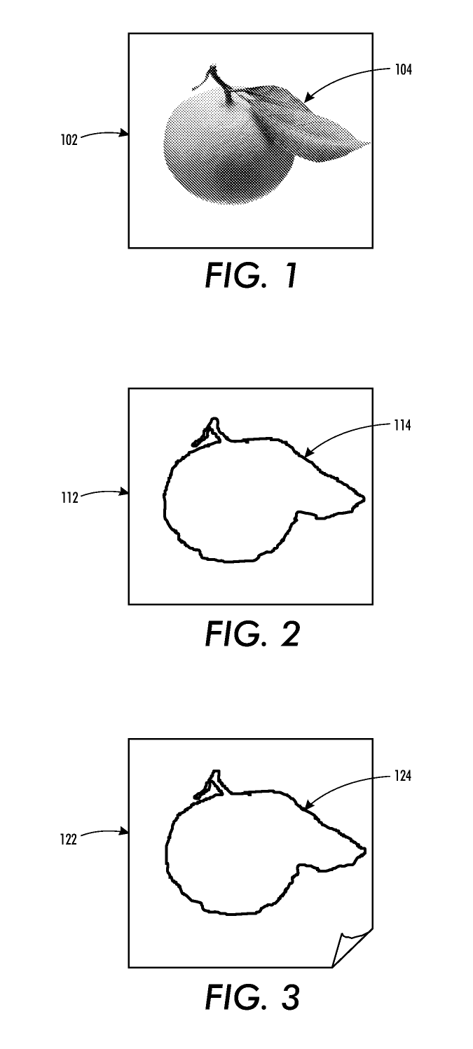

More specifically, an outline of a picture can be generated manually by the user, or automatically using any convention imaging software (e.g., Photoshop, available from Adobe, Inc., San Jose, Calif., USA) to manipulate the image and extract its outline. For example, as illustrated in FIG. 1, a file, document, presentation, etc., can include an image 102 of an item 104 (such as a piece of fruit). With embodiments herein, a separate outline drawing is created through user input or automatically (automatically means that the process is performed by a machine, without additional user action).

The new “outline” image can then be separated from the rest of the image 102 and processed as a separate second image. Therefore, as shown in FIG. 2, a second image 112 can be created that includes only a line drawing 114 of a single line outline of the original item 104.

Alternatively, as shown in FIGS. 5 and 6, different silhouette outlines of the item 104 can be automatically created using off the shelf software programs. FIG. 5 illustrates a second image 112 that is a silhouette outline 116 of the item 104 and item 118 in FIG. 6 illustrates a second image 112 that is a partial silhouette outline image 118 of the item 104. All such images (and similar images) are sometimes referred to herein as outlines. FIGS. 2, 5 and 6 are merely a few of many different outlines of item 104; and those ordinarily skilled in the art would understand that many other outlines of the item 104 can be utilized by embodiments herein, and that the embodiments herein are not limited to the exemplary outlines shown in FIGS. 2, 5, and 6.

The job ticket can then be programmed to perform embossing for the second image 112. As shown in FIG. 3, a printing process that utilizes a clear or colored marking material (toner, wet or dry ink, etc., that is black or color, or that is a clear gloss material) prints the marking material 124 in the pattern of the second image 112 on a sheet of media 122.

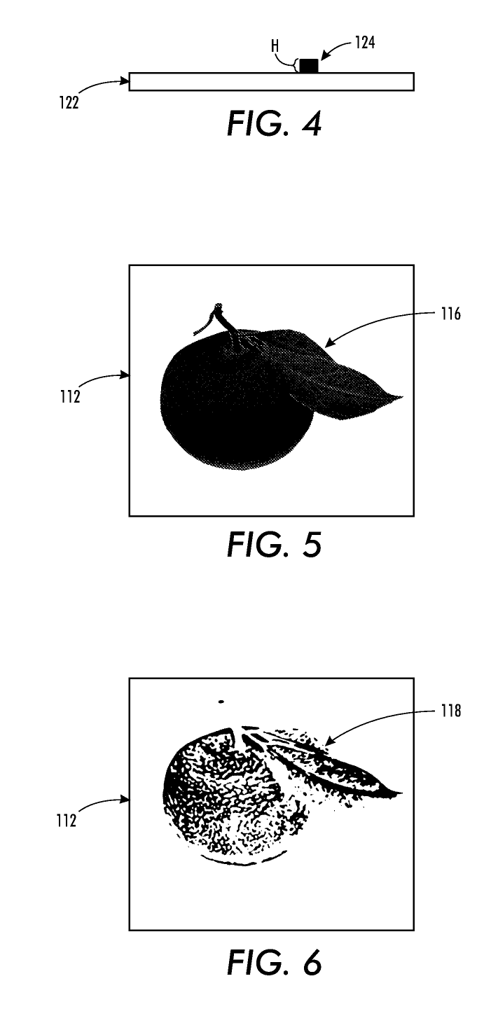

FIG. 4 is a cross-sectional view of the sheet of media 122. As shown in FIG. 4, the marking material 124 is printed at a sufficient thickness or height (H) above the printing surface of the sheet of media 122 to create a topographical feature on the sheet of media 122 so that it is detectible by a human touch. The height (H) of the marking material 124 can be controlled in a number of different ways including increasing the contrast level, causing the printing heads to deposit an excessive amount of marking material in a single pass, etc. Such an excessive amount of marking material might make an overly contrasted, blurry, or distorted optical image that may not be visually desirable; however, because the purpose here is to form a topographical feature, such excessive amounts of contrast or marking material are acceptable. Alternatively, the same pattern of marking material can be printed on the same sheet at the same location multiple times by using multiple printing engines and/or by repeatedly returning the sheet to the printing engine through a feedback path for multiple-pass printing.

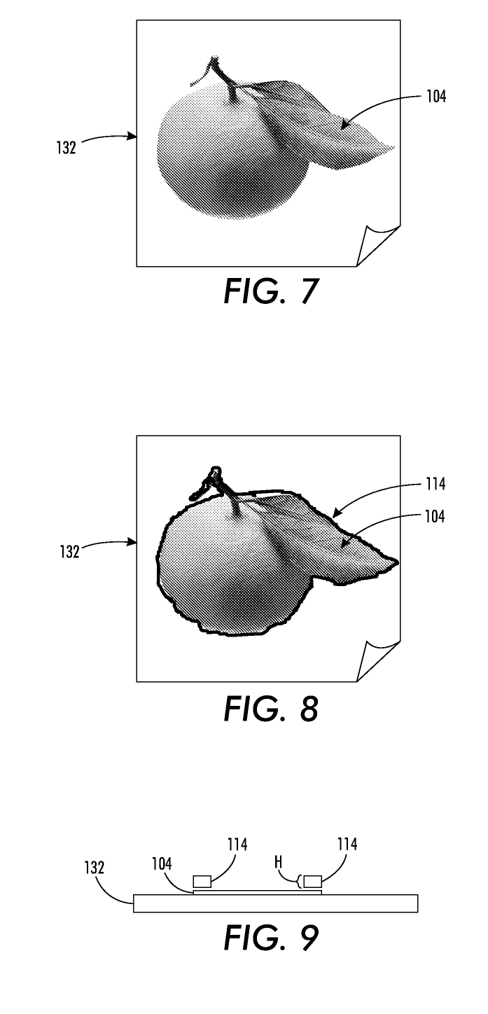

FIGS. 7 and 8 illustrate another embodiment herein where the raised topographical feature 114 is printed over a previously made print of the image 104. More specifically, the image 104 is first printed on a sheet of media 132 (FIG. 7) and then, in a subsequent printing process using a transparent ink or toner (gloss toner, etc.) any of the patterns mentioned above (e.g., single line outline 114) is printed on the previously printed image 104 (shown in FIG. 8). As was done in FIG. 4, above, FIG. 9 illustrates the sheet 132 in cross-section and demonstrates that the transparent marking material 114 is printed at a sufficient thickness or height (H) above the previous printing 104 on the sheet of media 132 to create a topographical feature on the sheet of media 132 so that it is detectible by a human touch.

Additionally, the process embodiments herein can be utilized with many different types of devices including, printers, digital cameras, and picture processing equipment, etc. Further, such devices can include touch screens, etc., to receive input from a stylus for manipulating and creating the outline of a picture for later embossed printing.

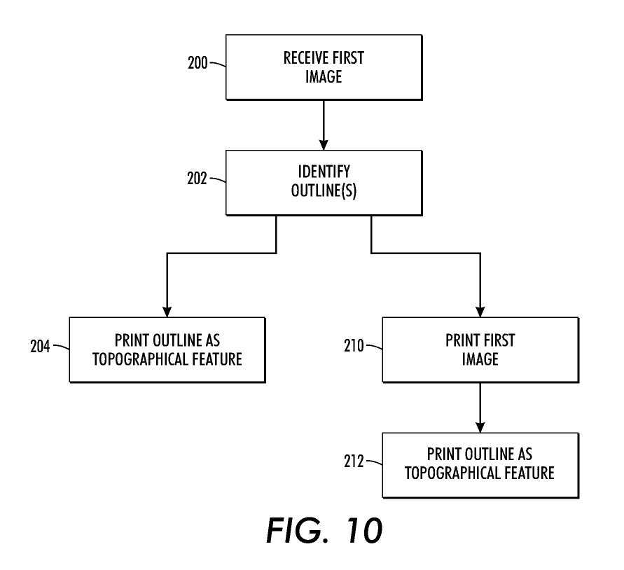

FIG. 10 is flowchart illustrating an exemplary method herein. In item 200, this method receives a first image. The first image comprises one or more visible features. This exemplary method then processes the first image to identify one or more outlines of the visible features and stores the outline(s) as a second image in item 202. In some embodiments, the second image can consist only of a background and the outline(s).

Some methods herein emboss the second image on a sheet of media as an embossed print in item 204. The embossing processes comprises printing marking material on the sheet of media in a pattern matching the outline(s) using a predetermined quantity of marking material, which is a sufficient amount of marking material to create a topographical feature on the sheet of media detectible by a human touch. The printing can comprise ink jet printing of visible or clear ink, or laser printing of visible or clear toner. The topographic features are formed by a mass of the marking material extending from a surface of the sheet of media and, for example, the topographic feature can have a height of at least 0.25 mm (e.g., 0.5 mm, 1.0 mm, 1.5 mm, etc.) above the surface of the sheet.

Other methods herein can alternatively first print the first image on a sheet of media as a visibly printed sheet in item 210. Then, this alternative embosses the second image on the visibly printed sheet as an embossed print in item 212. This embossing process again comprises printing marking material on the visibly printed sheet in a pattern matching the at least one outline using a predetermined quantity of transparent marking material. Again, the predetermined quantity of marking material comprises a sufficient amount of marking material to create a topographical feature on the visibly printed sheet detectible by a human touch.

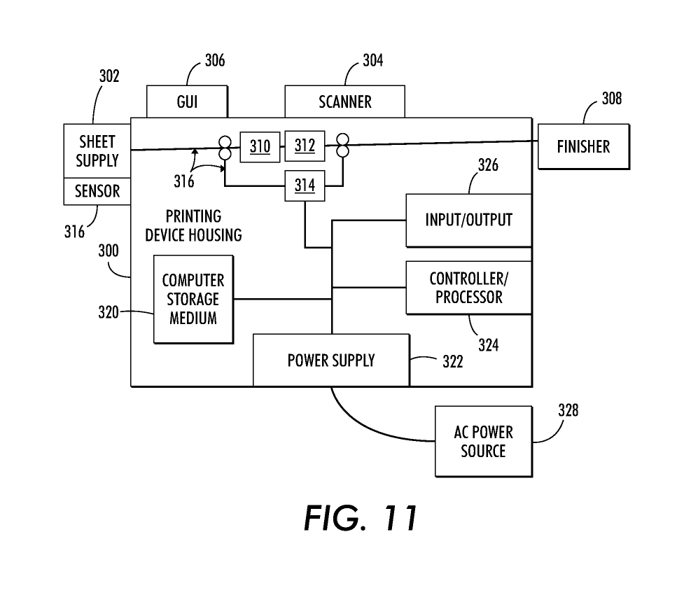

FIG. 11 illustrates a computerized printing device 300, which can be used with embodiments herein and can comprise, for example, a printer, copier, multi-function machine, etc. The printing device 300 includes a controller/processor 324, at least one marking device (printing engine) 310, 312, 314 operatively connected to the processor 324, a media path 316 positioned to supply sheets of media from a sheet supply 302 to the marking device(s) 310, 312, 314, and a communications port (input/output) 326 operatively connected to the processor 324 and to a computerized network external to the printing device. After receiving various markings from the printing engine(s), the sheets of media can optionally pass to a finisher 308 which can fold, staple, sort, etc., the various printed sheets.

Also, the printing device 300 can include at least one accessory functional component (such as a scanner/document handler 304, sheet supply 302, finisher 308, etc.) and graphic user interface assembly 306 that also operate on the power supplied from the external power source 328 (through the power supply 322).

The input/output device 326 is used for communications to and from the multi-function printing device 300. The processor 324 controls the various actions of the printing device. A non-transitory computer storage medium device 320 (which can be optical, magnetic, capacitor based, etc.) is readable by the processor 324 and stores instructions that the processor 324 executes to allow the multi-function printing device to perform its various functions, such as those described herein.

Thus, a printer body housing 300 has one or more functional components that operate on power supplied from the alternating current (AC) 328 by the power supply 322. The power supply 322 connects to an external alternating current power source 328 and converts the external power into the type of power needed by the various components.

As would be understood by those ordinarily skilled in the art, the printing device 300 shown in FIG. 11 is only one example and the embodiments herein are equally applicable to other types of printing devices that may include fewer components or more components. For example, while a limited number of printing engines and paper paths are illustrated in FIG. 11, those ordinarily skilled in the art would understand that many more paper paths and additional printing engines could be included within any printing device used with embodiments herein.

In such a computerized (printing) device 300, the processor 324 receives a first image. Again, the first image comprises at least one visible feature. The processor 324 processes the first image to identify at least one outline of the feature(s). The processor 324 stores the outline(s) as a second image in the computer-readable storage device 320.

The marking engine(s) 310, 312, 314 can comprise an ink jet print engine printing visible or clear ink (solid or liquid); or a laser print engine printing visible or clear toner. The marking engine(s) 310, 312, 314 emboss the second image on a sheet of media as an embossed print. The embossing process again comprises the marking engine(s) 310, 312, 314 printing marking material on the sheet of media in a pattern matching the outline(s) using a predetermined quantity of marking material, which is a sufficient amount of marking material to create a topographical feature on the sheet of media detectible by a human touch.

Many computerized devices are discussed above. Computerized devices that include chip-based central processing units (CPU's), input/output devices (including graphic user interfaces (GUI), memories, comparators, processors, etc., are well-known and readily available devices produced by manufacturers such as Dell Computers, Round Rock Tex., USA and Apple Computer Co., Cupertino Calif., USA. Such computerized devices commonly include input/output devices, power supplies, processors, electronic storage memories, wiring, etc., the details of which are omitted herefrom to allow the reader to focus on the salient aspects of the embodiments described herein. Similarly, scanners and other similar peripheral equipment are available from Xerox Corporation, Norwalk, Conn., USA and the details of such devices are not discussed herein for purposes of brevity and reader focus.

The terms printer or printing device as used herein encompasses any apparatus, such as a digital copier, bookmaking machine, facsimile machine, multi-function machine, etc., which performs a print outputting function for any purpose. The details of printers, printing engines, etc., are well-known by those ordinarily skilled in the art and are discussed in, for example, U.S. Pat. No. 6,032,004, the complete disclosure of which is fully incorporated herein by reference. The embodiments herein can encompass embodiments that print in color, monochrome, or handle color or monochrome image data. All foregoing embodiments are specifically applicable to electrostatographic and/or xerographic machines and/or processes.

In addition, terms such as “right”, “left”, “vertical”, “horizontal”, “top”, “bottom”, “upper”, “lower”, “under”, “below”, “underlying”, “over”, “overlying”, “parallel”, “perpendicular”, etc., used herein are understood to be relative locations as they are oriented and illustrated in the drawings (unless otherwise indicated). Terms such as “touching”, “on”, “in direct contact”, “abutting”, “directly adjacent to”, etc., mean that at least one element physically contacts another element (without other elements separating the described elements).

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. The claims can encompass embodiments in hardware, software, and/or a combination thereof. Unless specifically defined in a specific claim itself, steps or components of the embodiments herein cannot be implied or imported from any above example as limitations to any particular order, number, position, size, shape, angle, color, or material.

What is claimed is:

1. A method comprising:
receiving a first image, said first image comprising at least one visible feature;
processing said first image to identify at least one outline of said at least one visible feature;
storing said at least one outline as a second image; and
embossing said second image on a sheet of media as an embossed print,
said embossing comprising printing marking material on said sheet of media in a pattern matching said at least one outline using a predetermined quantity of marking material, and
said predetermined quantity of marking material comprising a sufficient amount of marking material to create a topographical feature on said sheet of media detectible by a human touch.

2. The method according to claim 1, said printing comprising one of ink jet printing of visible or clear ink, and laser printing of visible or clear toner.

3. The method according to claim 1, said second image consisting only of a background and said at least one outline.

4. The method according to claim 1, said topographic feature being formed by a mass of said marking material extending from a surface of said sheet of media.

5. The method according to claim 1, said topographic feature comprising a height of at least 0.25 mm.

6. A method comprising:
receiving a first image, said first image comprising at least one visible feature;
processing said first image to identify at least one outline of said at least one visible feature;
storing said at least one outline as a second image;
printing said first image on a sheet of media as a visibly printed sheet; and
embossing said second image on said visibly printed sheet as an embossed print,
said embossing comprising printing marking material on said visibly printed sheet in a pattern matching said at least one outline using a predetermined quantity of marking material, and
said predetermined quantity of marking material comprising a sufficient amount of marking material to create a topographical feature on said visibly printed sheet detectible by a human touch.

7. The method according to claim 6, said printing comprising one of ink jet printing of clear ink, and laser printing of clear toner.

8. The method according to claim 6, said second image consisting only of a background and said at least one outline.

9. The method according to claim 6, said topographic feature being formed by a mass of said marking material extending from a surface of said visibly printed sheet.

10. The method according to claim 6, said topographic feature comprising a height of at least 0.25 mm.

11. A printing machine comprising:
at least one processor;
at least one computer-readable storage device operatively connected to said processor; and
at least one marking engine operatively connected to said processor,
said processor receiving a first image, said first image comprising at least one visible feature,
said processor processing said first image to identify at least one outline of said at least one visible feature,
said processor storing said at least one outline as a second image in said computer-readable storage device,
said marking engine embossing said second image on a sheet of media as an embossed print,
said embossing comprising said marking engine printing marking material on said sheet of media in a pattern matching said at least one outline using a predetermined quantity of marking material, and
said predetermined quantity of marking material comprising a sufficient amount of marking material to create a topographical feature on said sheet of media detectible by a human touch.

12. The printing machine according to claim 11, said marking engine comprising one of ink jet print engine printing visible or clear ink and a laser print engine printing visible or clear toner.

13. The printing machine according to claim 11, said second image consisting only of a background and said at least one outline.

14. The printing machine according to claim 11, said topographic feature being formed by a mass of said marking material extending from a surface of said sheet of media.

15. The printing machine according to claim 11, said topographic feature comprising a height of at least 0.25 mm.

16. A computer storage device comprising a non-transitory computer storage medium storing instructions executable by a computer, said instruction causing said computer to perform a method comprising:
receiving a first image, said first image comprising at least one visible feature;
processing said first image to identify at least one outline of said at least one visible feature;
storing said at least one outline as a second image; and
embossing said second image on a sheet of media as an embossed print,
said embossing comprising printing marking material on said sheet of media in a pattern matching said at least one outline using a predetermined quantity of marking material, and
said predetermined quantity of marking material comprising a sufficient amount of marking material to create a topographical feature on said sheet of media detectible by a human touch.

17. The computer storage device according to claim 16, said printing comprising one of ink jet printing of visible or clear ink, and laser printing of visible or clear toner.

18. The computer storage device according to claim 16, said second image consisting only of a background and said at least one outline.

19. The computer storage device according to claim 16, said topographic feature being formed by a mass of said marking material extending from a surface of said sheet of media.

20. The computer storage device according to claim 16, said topographic feature comprising a height of at least 0.25 mm.
